(19) United States
(12) Patent Application Publication
(10) Pub. No.: US 2026/0243685 A1
(43) Pub. Date: Aug. 20, 2026

(54) LOW-SNR OPTICAL DETECTION TECHNIQUE USING DESTRUCTIVE INTERFERENCE

(71) Applicant: Liom Health AG, Pfäffikon (CH)

(72) Inventors: Jens HOFRICHTER, Horgen (CH); Adler PEROTTE, Zürich (CH)

(73) Assignee: Liom Health AG, Pfäffikon (CH)

(21) Appl. No.: 19/134,354

(22) PCT Filed: Nov. 30, 2022
(86) PCT No.: PCT/EP2022/083808

§ 371 Date: May 30, 2025

(51) Int. Cl. G01N 21/65; G01B 9/02; G01B 9/02001; G01B 9/02002; G01B 9/02015

(52) U.S. Cl. CPC G01N 21/65; G01B 9/02005; G01B 9/0201; G01B 9/02027; G01B 9/02041; G01N 2201/06106; G01N 2201/0698; G01N 2201/12723

(57) ABSTRACT

At least one sample parameter of a sample (16) is measured by means of probe light. The probe light is split to into sample probe light and reference probe light. The sample probe light interacts with the sample (16), which generates modified probe light having a phase and/or intensity depending on the sample parameter. The modified probe light and the reference probe light are overlapped to interfere, thereby generating signal light, and the intensity of the signal light is measured. A tuning parameter (t1, t2, t1′, t2′, t1″, t2″) is determined from the intensity of the signal light and used to control a phase and/or intensity tuner (20, 32, 52, 70′, 70″) in order to make the interference destructive, thereby minimizing or at least reducing the measured intensity. The sample parameter is determined using the intensity parameter and/or the tuning parameter. This technique reduces shot noise. It can be used in a plurality of applications, but a particularly preferred application is in stimulated Raman scattering or NIR reflection/absorption spectroscopy.

### TECHNICAL FIELD

The invention relates to a method for optically measuring at least one parameter of a sample as well as to an optoelectronic measurement device implementing this method. It also relates to a use of the method or device for stimulated Raman spectroscopy measurements.

### BACKGROUND ART

Numerous detection methods are based on causing sample probe light to interact with a sample, thereby generating modified probe light that has a phase and/or intensity depending on a sample parameter to be measured.

Typically, the modified probe light is then fed to a photodetector, where an intensity parameter is measured, with the intensity parameter depending on the sample parameter.

In one known application, for example, an elastic or inelastic scattering parameter is measured by sending the sample probe light into the sample and receiving scattered light as modified probe light. In another application, the absorption of the sample is measured by sending the sample probe light through the sample and measuring the transmitted modified probe light.

In another example, the optical length of a sample is measured by sending the sample probe light through the sample to generate the modified probe light that has a phase shift depending on the optical length. The modified probe light is made to interfere with reference probe light from the same light source, which allows to measure its relative phase

In another example, for measuring stimulated Raman spectroscopy (SRS) or another third-order nonlinear optical effect in the sample, secondary light is sent into the sample, in addition to the sample probe light. The secondary light has a wavelength different from the probe light. Depending on the interaction between the two light fields and the molecules within the probe, the intensity of the modified probe light may vary as a function of the amount of secondary light. Again, the modified probe light needs to be measured accurately.

### DISCLOSURE OF THE INVENTION

The problem to be solved by the present invention is to provide a method and measurement device of this type that allow to measure the sample parameter with high accuracy.

This problem is solved by the method and device of the independent claims.

Accordingly, the method for optically measuring at least one sample parameter of a sample comprises at least the following steps:
Generating “probe light” by means of a probe light source: This is the light that is to be detected after it has interacted with the sample.
Splitting the probe light into “sample probe light” and “reference probe light”: The sample probe light is to interact with the sample while the reference probe light will be used for interference in a later step of the method.
Causing the sample probe light to interact with the sample, thereby generating “modified probe light”: The phase and/or intensity of the modified probe light depends on the sample parameter that is to be measured.
Causing the modified probe light to interfere with the reference probe light at a beam combiner, thereby generating “signal light”: The signal light is the light resulting from the interference of the modified probe light and the reference probe light.
Measuring at least one “intensity parameter” of the signal light by means of at least one photodetector: The intensity parameter is a parameter depending on the intensity (i.e. power) of the signal light.
Deriving at least one “tuning parameter” using the intensity parameter and controlling a phase and/or intensity tuner by means of the tuning parameter. The phase and/or intensity tuner modifies (as a function of the tuning parameter) the relative phase and/or intensity of the interfering reference probe light and the modified probe light at the beam combiner to make them interfere destructively, thereby reducing or even zeroing the intensity parameter: In other words, the phase and/or intensity of the reference probe light and/or the modified probe light is varied in order to change the way they interfere with each other. Namely, they are to interfere destructively, thereby reducing or even zeroing the intensity parameter.
Deriving the sample parameter using the intensity parameter and/or the tuning parameter: In other words, the sample parameter is derived by using the intensity parameter, i.e., by using the signal measured by the photodetector, and/or the tuning parameter, i.e., by using the amount of intensity and/or phase change to achieve destructive interference.

This technique allows to perform measurements at an operating point of the photodetector where the intensity parameter is small, i.e., the amount of light at the photodetector is low. Hence, the relative amount of shot noise (which grows with the square root of the intensity at the photodetector) is low, which allows to make measurements with a larger signal-to-noise ratio, i.e., to make more accurate measurements, when the background is regarded as noise.

In an advantageous embodiment, the method comprises the following steps:
Repetitively deriving said tuning parameter at a plurality of times and minimizing the intensity parameter at said plurality of times: In other words, at said plurality of times, fully destructive interference is established at the photodetector by minimizing its signal.
Deriving the sample parameter using the tuning parameters at said plurality of times: The tuning parameters correspond to the correction of the intensity and/or phase that leads to fully destructive interference, i.e. the tuning parameters are substantially free of shot noise. Hence, this allows to perform a measurement with excellent SNR.

The sample parameter may be derived using the tuning parameter but not the intensity parameter. Again, this allows performing a measurement that is substantially free of shot noise.

In another embodiment, the method may comprise the following steps:
a) Deriving the tuning parameter and reducing the intensity parameter: In other words, the derived tuning parameter is used to control the phase and/or intensity tuner and thereby to reduce the measured intensity parameter, advantageously by at least a factor 10, in particular by at least a factor 100, as compared to the situation before changing the tuning parameter.
b) After step a), keeping the tuning parameter unchanged and measuring the intensity parameter at several times: As the measurement parameters and/or the probe change and, therefore, the relative phase and/or intensity of the modified probe light and the reference probe light change, the intensity parameter, which starts to deviate from its original value after tuning, is measured.
c) Deriving the sample parameter using the intensity parameters measured at the times of step b).

This embodiment is particularly suited for systems where the changes of intensity and/or phase are small over a measurement period, i.e. during step b) the intensity at the photodetector will remain small. Hence, shot noise will again be small even if the sample parameter is determined, at least in part, from intensity parameters.

Splitting the probe light into the sample probe light and the reference probe light may take place in a tunable beam splitter, i.e., in a beam splitter where the intensity ratio between the sample probe light and the reference probe light can be varied by means of a control signal. In this case, the tuning parameter may be used to tune the splitting ratio of the tunable beam splitter. This allows for a more efficient use of the probe light as compared to methods where part of the reference probe light and/or part of the sample probe light or modified probe light is absorbed or removed.

If the relative phase of the reference probe light and the modified probe light is to be modified, a tunable phase shifter may be used. This tunable phase shifter can be arranged in the path of the sample probe light, in the path of the modified probe light, or in the path of the reference probe light. The tuning parameter can in this case used to tune the phase delay of the tunable phase shifter.

In a particularly advantageous embodiment, the present method can be used to measure third order nonlinear optical effects, such as stimulated Raman scattering (SRS) in the probe. To do so, the method may further comprise at least the following steps:
Generating secondary light by means of a secondary light source: This secondary light advantageously has a wavelength different from the probe light. It will interact, at the sample, with the probe light.
Overlapping the secondary light and the sample probe light at the sample and causing the secondary probe light and the sample probe light to interact with the sample, thereby generating the modified probe light having a phase and/or intensity depending on said sample parameter as well as on the intensity of the secondary probe light.

In this case, the intensity and/or phase of the modified probe light typically varies, slightly, as a function of the intensity of the secondary light. In conventional detection schemes, this small variation is hard to detect due to the shot noise generated by the DC background of the modified probe light in the photodetector. However, with the present scheme, this DC background can be removed or at least strongly reduced by destructive interference between the modified probe light and the reference probe light.

For SRS applications, the wavenumber difference between the probe light and the secondary light is advantageously less than 3800 cm⁻¹ in order to couple to vibrational or rotatory modes of typical molecules. On the other hand, the wavenumber difference is advantageously at least 10 cm⁻¹ for Raman scattering.

The technique can also be used for Brillouin scattering measurements, in which case the wavenumber difference between the probe light and the secondary light is advantageously in a range between 0.1 and 6 cm⁻¹.

In terms of wavelength, the wavelengths of both the probe light as well as the secondary light are advantageously in the “biological windows” between 650 nm and 1870 nm, and they differ by at least 1 nm but by no more than 200 nm.

Advantageously, the method comprises at least the following steps:
Changing the wavelength of the probe light source or the secondary light source.
Determining the sample parameter for several different wavelengths.

In this case, in a first option, the tuning parameter(s) can be determined from the intensity parameter for each wavelength. Then, the phase and/or intensity tuner can be controlled by means of the tuning parameter to modify a relative phase and/or intensity of the reference probe light and the modified probe light to make them interfere destructively, thereby minimizing the intensity parameter for each wavelength. The material parameter is then derived from the tuning parameter. Since all measurements correspond to a situation is fully destructive interference, SNR will be low.

In another option, tuning is not carried out for every wavelength, which makes the procedure faster. In this case, the method comprises the following steps:
a) For a first wavelength, deriving the tuning parameter from the intensity parameter and controlling the phase and/or intensity tuner by means of the tuning parameter to modify a relative phase and/or intensity of the reference probe light and the modified probe light to make them interfere destructively, thereby reducing the intensity parameter.
b) After said step a), keeping the tuning parameter unchanged and measuring the intensity parameter for several second wavelengths.
c) Deriving the sample parameter at the second wavelengths using the intensity parameters measured at the second wavelengths.

Advantageously, the coherence length of the probe light, and (if used) of the secondary light, should be at least 10 mm, in particular at least 100 mm, and it may even be e.g. up to 10 km. This makes tuning the device easier because the path lengths of reference and probe light do not have to match exactly. In addition, it provides a better contrast and more complete destructive interference even if the components and/or the probe exhibit strong dispersion.

The invention also relates to an optoelectronic measurement device comprising at least:
a probe light source,
a probe light splitter connected to the probe light source,
a sample interface connected to the probe light splitter,
a beam combiner connected to the probe light splitter and the sample interface,
a photodetector connected to the beam combiner,
a phase and/or intensity tuner, and
a control unit adapted to carry out the method of any of the preceding claims.

In a particularly advantageous application, the present device or method are used for stimulated Raman spectroscopy where the measurement at low intensities at destructive interference is particularly suited to improve the SNR of the measurement results.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 shows a first embodiment of a measurement device,

FIG. 2 shows a second embodiment of a measurement device,

FIG. 3 shows a third embodiment of a measurement device,

FIG. 4 shows a fourth embodiment of a measurement device,

FIG. 5 shows a fifth embodiment of a measurement device,

FIG. 6 shows a sixth embodiment of a measurement device,

FIG. 7 shows an interferometric tunable coupler,

FIG. 8 shows the sample parameter, the measured intensity parameter I1, and the tuning parameter t1 over a series of measurements xi in a system that tries to keep interference fully destructive, and

FIG. 9 shows the sample parameter, the measured intensity parameter I1, and the tuning parameter t1 over a series of measurements xi in a system that allows for deviations from fully destructive interference.

### MODES FOR CARRYING OUT THE INVENTION

### First Embodiment

FIG. 1 shows some general concepts of the present technique that can be applied to various embodiments thereof. In particular, it shows a measuring device 10, which advantageously comprises optoelectronic circuitry on a substrate 12.

A probe light source 14 generates probe light that is to be used to measure at least one sample parameter of a sample 16. The probe light is sent, e.g. by means of an integrated waveguide 18, to a tunable splitter, the “probe light splitter” 20, where it is split into sample probe light and reference probe light. The sample probe light is sent, e.g. by means of a waveguide 22, a device terminal 24, and suitable imaging optics (not shown) to a sample 16.

The sample probe light is caused to interact with sample 16. This interaction can include a variety of mechanisms, such as elastic or inelastic scattering, reflection, or transmission. The following description will provide more specific examples of interactions.

For the following, by way of example, it is assumed that the interaction is elastic scattering.

The interaction of the sample probe light with sample 16 generates modified probe light having a phase and/or intensity depending on a sample parameter p. For example, for elastic scattering, the absorption and scattering properties of the sample will affect the phase as well as the intensity of the modified probe light.

The modified probe light may be collected by means of suitable collection optics (not shown) and fed to a device terminal 26 of device 10. From there, it e.g. propagates through a waveguide 28 to a first input port of a beam combiner 30.

At the same time, the reference probe light from probe light splitter 20 is e.g. sent through a tunable phase shifter 32 and a waveguide 34 to a second input port of beam combiner 30.

In beam combiner 30, the reference probe light and the modified probe light are combined into “signal light” and e.g. emitted through an output port into a waveguide 36, from where the signal light reaches a photodetector D1, such as a photodiode.

Photodetector D1 is connected to an amplifier 38 and an ADC 40 to generate an intensity parameter I1. Intensity parameter I1 is descriptive of, advantageously linear to, the intensity of the signal light, i.e. the intensity of the interfering reference probe light and modified probe light at the location of photodetector D1.

In general terms, assuming that the reference probe light has an intensity Iᵣ, the modified probe beam has an intensity Iₘ, and their mutual phase shift at photodiode D1 is Δφ, the intensity I of the interfering light is given by

$$I = {I}_{r} + {I}_{m} + 2 \sqrt{{I}_{r} \cdot {I}_{m}} \cdot cos ( Δφ ) . \qquad ( 1 )$$

Hence, in general, the intensity parameter will have a DC offset given by Iᵣ+Iₘ and oscillate with the phase shift.

In general, unless the intensities Iᵣ and Iₘ are equal and the phase shift is a multiple of 2π, the intensity I will be non-zero.

As known to the skilled person, a photodetector such as a photodiode generates, when measuring a light intensity, a signal depending on the light intensity I overlaid by shot noise, with the signal-to-noise ratio being roughly proportional to √I.

Hence, if the changes in the sample parameter p have but a weak influence on Iₘ and Δφ, they become hard to detect against the shot noise if the DC intensity I at photodiode D1 is comparatively large.

Therefore, device 10 comprises a control unit 42 (such as a digital signal processor or some other computing means, such as a microprocessor or a computer or analog processing circuitry) adapted to derive at least one tuning parameter from the measured intensity parameter I1. This tuning parameter is used to modify the relative phase Δφ and/or the relative intensity Iᵣ:Iₘ of the reference probe light and the modified probe light to make them interfere destructively at photodiode D1, thereby minimizing the intensity parameter I1. In other words, the components of device 10 are tuned to make Iᵣ=Iₘ and to set Δφ=π/2+n·T, with n being a natural number.

In the embodiment of FIG. 1, it is assumed that both the relative intensity Iᵣ:Iₘ as well as the relative phase Δφ are to be tuned, which will be the case in most applications.

In the shown embodiment, the relative intensity Iᵣ:Iₘ is tuned by means of using a tunable probe light splitter 20. Control unit 42 generates a first tuning parameter t1 that controls the ratio between the intensities at the two outputs of probe light splitter 20. Examples for such a tunable splitters are described in more detail below.

Further, in the shown embodiment, the relative phase Δφ is tuned by means of tunable phase shifter 32. Phase shifter 32 may e.g. comprise a section of waveguide and an electric heater for changing the temperature of the section of waveguide, thereby changing the effective refractive index of the waveguide. It may also comprise a section of waveguide and electrodes to apply an electrical field to the waveguide, thereby changing its refractive index via the Pockels or Kerr effect. Devices of this type are known to the skilled person.

Control unit 42 generates a second tuning parameter t2 that controls the phase shift generated by tunable phase shifter 32.

Advantageously, control unit 42 implements a control loop that repetitively measures intensity parameter I1 and changes the tuning parameter(s) t1, t2 to minimize the value of intensity parameter I1.

Ideally, the intensity I at photodiode D1 is therefore kept at zero, i.e. totally destructive interference between the modified probe light and the reference probe light is maintained, which minimizes the shot noise generated by photodiode D1.

The sample parameters p can then be determined from the amount of tuning required for the relative intensity and/or phase shift, i.e. from the tuning parameter(s) t1, t2.

For this purpose, device 10 advantageously has one or more output terminals 44, 46 that e.g. carry signals indicative of the tuning parameter(s) t1, t2.

### Second Embodiment

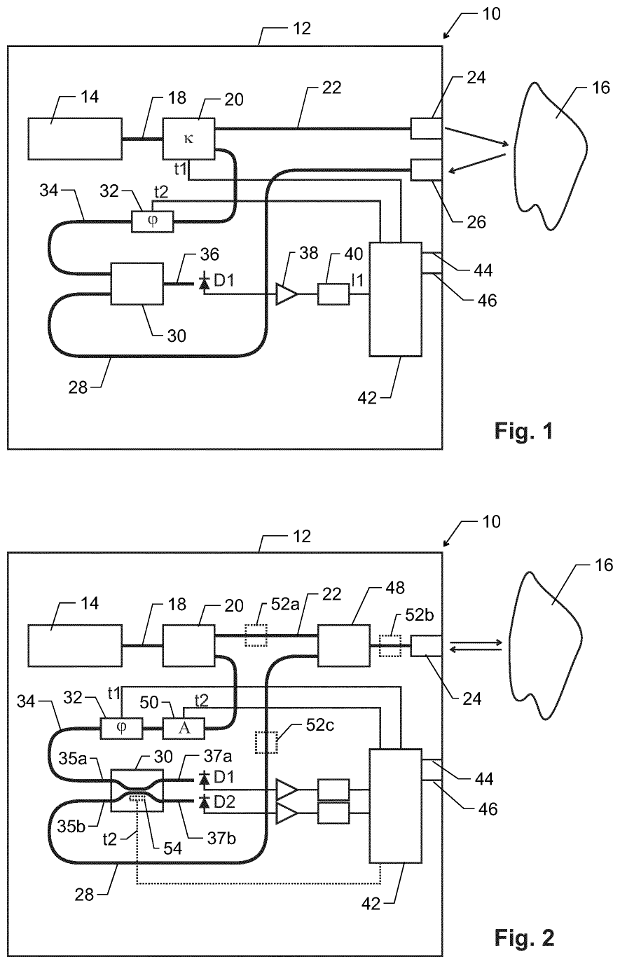

FIG. 2 again illustrates a variety of general concepts of the present technique that can be applied to various embodiments thereof.

For one, the embodiment of FIG. 2 differs from the one of FIG. 1 in that a single device terminal 24 is used to emit the sample probe light from device 10 and to receive the modified probe light returning from sample 16. A splitter 48 is provided for separating the outgoing sample probe light from the incoming modified probe light.

Further, the embodiment of FIG. 2 differs from the one of FIG. 1 in that probe light splitter 20 is not a tunable splitter. Rather, splitter 20 splits the sample probe light and the reference probe light with a fixed ratio of intensities. To tune the ratio of intensities, a tunable amplitude modulator 50, separate from probe light splitter 20, is provided.

In the embodiment of FIG. 2, tunable phase shifter 32 and tunable amplitude modulator 50 are both arranged along waveguide 34, i.e. in the path of the reference probe light. Alternatively (or in addition), one or both may also be arranged in the path of the sample probe light and/or the modified probe light, e.g., at one of the positions 52a, 52b and/or 52c of FIG. 2.

In yet another embodiment, tunable phase shifter 32 and/or tunable amplitude modulator 50 may form part of beam combiner 30.

Further, the embodiment of FIG. 2 differs from the one of FIG. 1 in that beam combiner 30 has two complementary outputs 37a, 37b and is adapted to cross-couple the two inputs 35a, 35b, making them interfere. Advantageously, beam combiner 30 is structured such that the ratio between the light powers at its outputs 37a, 37b depends on the phase shift between the reference probe light and the modified probe light at its inputs. This ratio is 1:0 (i.e. one of the outputs carries no light while the other output carries all light) if the ratio of light power at its inputs corresponds to a target ratio Rt (e.g. 1:1) and the relative phase shift of the light between its inputs is equal to a target phase shift Δφ (e.g.) 0°.

(The conditions above are advantageously met at least at the center wavelength of the probe light.)

A combiner 30 having properties as above can e.g. be implemented by providing two parallel sections of waveguides of suitable length with evanescent coupling between them as shown in FIG. 2.

In this case, photodetector D1 is positioned to measure the light from the output 37a that becomes zero at the for the input power ratio Rt and the target phase shift Δφ.

Same as in the first embodiment, control unit 42 is adapted to set the tuning parameter(s) t1, t2 such that intensity signal I1 of D1 becomes zero, i.e. the tuning parameter(s) t1, t2 are chosen such that the input power ratio is equal to the target input power ratio Rt and the relative phase shift between the light at the two inputs 35a, 35b is equal to the target phase shift Δφ.

In the embodiment of FIG. 2, a second photodetector D2 is provided to measure the light at the second output 37b of combiner 30, which allows to measure the total light power, e.g. for monitoring the proper operation of the device and/or to make sure that reference probe light is present.

In yet a further embodiment, beam combiner 30 may be a tunable beam combiner, e.g. by placing a heater 54 along the two coupled waveguides as indicated with dotted lines in FIG. 2. In this case, changing the temperature of heater 54 changes the beat length of the coupling between the two coupled waveguide sections of beam combiner 30, thereby changing the relative intensities of the reference probe light and the modified probe light as they interfere at the outputs of beam combiner 30. In this case, tunable amplitude modulator 50 may be dispensed with.

A beam combiner 30 of this type is e.g. described by D. PérezLópez et al in Optics Express Vol. 27, No. 36, pp. 38071-38086, https://doi.org/10.1364/OE.27.038071 and the references therein.

### Third Embodiment

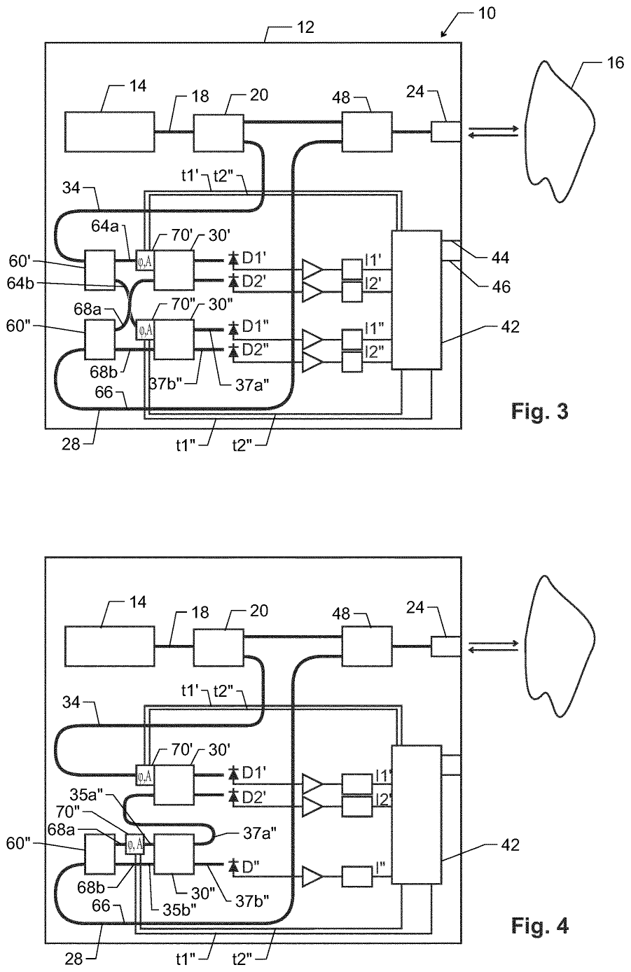

FIG. 3 again illustrates a variety of general concepts of the present technique that can be applied to various embodiments thereof.

Here, it is assumed that the interaction with sample 16 changes the polarization state of the modified probe light in a manner that depends on the parameter(s) of the sample that is/are to be measured.

For example, Raman scattering may change the polarization state of the probe light. Similarly, the probe may contain chiral components that are optically active and, depending on concentration, may change the polarization state of the probe light.

In this case, the amplitudes and/or phases of two polarization states of the modified probe light have to be measured.

In the present embodiment, splitters 60′, 60″ are provided to split the light of both the reference probe light and the modified probe light, at least one of these splitters, namely splitter 60″ used for the modified probe light, is a polarizing splitter.

In the example of FIG. 3, the splitters 60′, 60″ both have a fixed splitting ratio.

First splitter 60′ splits the reference probe light into a first reference branch 64a and into a second reference branch 64b.

The two polarization states of the modified probe light are fed, as two separate modes, through a waveguide 28 to second polarizing splitter 60″. There, they are separated into a first probe branch 68a and into a second probe branch 68b, i.e. first probe branch 68a carries the light of a first polarization state of the modified probe light while second probe branch carries the light of a second polarization state of the modified probe light.

The light in the first reference branch 64a and the first probe branch 68a is brought to interference in a first beam combiner 30′, and a first phase and/or amplitude tuner 70′ is used to make them interfere destructively at a first photodetector D1′. In the embodiment of FIG. 3, first phase and/or amplitude tuner 70′ is arranged in first reference branch 64a, but it may e.g. also be arranged in first probe branch 68a or be integrated, at least in part, in first beam combiner 30′, similar as in the embodiment of FIG. 2. First phase and/or amplitude tuner 70′ is controlled by tuning parameters t1′, t2′ generated by control unit 42.

The light in the second reference branch 64b and the second probe branch 68b is brought to interference in a second beam combiner 30″. A second phase and/or amplitude tuner 70″ is used to make them interfere destructively at a second photodetector D1″. In the embodiment of FIG. 3, second phase and/or amplitude tuner 70″ is arranged in second reference branch 64b, but it might also be arranged in second probe branch 68b or be integrated, at least in part, in second beam combiner 30″, similar as in the embodiment of FIG. 2. Second phase and/or amplitude tuner 70″ is controlled by tuning parameters t1″, t2″ generated by control unit 42.

Similar to the above embodiments, control unit 42 is then adapted to set the first tuning parameter(s) t1′, t2′ such that intensity signal I1′ of D1′ becomes zero. Also, control unit 42 is adapted to set the second tuning parameter(s) t1″, t2″ such that intensity signal I1″ of D1″ becomes zero.

In that case, the tuning parameter(s) t1′, t2′, t1″, t2″ are descriptive of the phase and/or amplitude of the two polarization states of the modified probe light returning from sample 16.

The beam splitters 60′ and 60″ and the beam combiners 30′ and 30″ must be structured such that the light of the two modes propagating through waveguide 28 interferes with the respective parts of the reference probe light from first splitter 60′.

In one embodiment, if the reference probe light in waveguide 34 is only propagating in one mode, e.g. TE0, first beam splitter 60′ may be a simple splitter coupling the light into the TE0 modes of the waveguides 64a, 64b at its outputs. If the two modes of the modified probe light in waveguide 28 are TE and TM modes of said waveguide, second polarizing beam splitter 60″ is advantageously a polarization rotator-splitter, e.g. as described by W. D. Sacher et al. in Optics Express 3777, Vol. 22(4), 3777-3786, DOI: 10.1364/OE.22.003777, which e.g. couples the two polarization states of the modified probe light into the TE0 modes of the waveguides 68a, 68b at its two outputs. In that case, the beam combiners 30′, 30″ are structured to cause the TE0 modes at their two respective inputs to interfere.

Other methods for combining the various modes, e.g. using TM0 modes instead of TE0 modes, are known to the skilled person.

### Fourth Embodiment

FIG. 4 again illustrates a variety of general concepts of the present technique that can be applied to various embodiments thereof.

Same as the third embodiment, the fourth embodiment is adapted to measure a change of polarization state of the modified probe light. In this embodiment, though, the outputs 68a, 68b of second polarizing beam splitter 60″, which is advantageously a polarization rotator-splitter as described in the previous section, are brought to interference with each other in second beam combiner 30″ after their relative phase shift and amplitudes have been tuned in phase and/or amplitude tuner 70″. Second beam combiner 30″ is again a beam combiner having two complementary outputs 37a″, 37b″. Same as in the second embodiment, the beam combiner 30″ is structured such that the ratio between the light powers at its outputs 37a″, 37b″ depends on the phase shift and relative power between the light at its inputs 35a″, 35b″. If, for example, the phase shift is zero and the power ratio of the light at its inputs 35a″, 35b″ is 1:1, all light is coupled to the first output 37a″ and no light is coupled to the second output 37b″.

Control unit 42 is adapted to tune phase and/or amplitude tuner 70″, by means of tuning parameters t1″, t2″ in order to minimize the signal I″ from the photodetector D″ detecting the light at second output 37b″.

This allows to determine the relative phase as well as the relative powers of the two modes of modified probe light in waveguide 28 from the respective tuning parameters t1″, t2″ that control phase and/or amplitude tuner 70″.

In the embodiment of FIG. 4, there is a phase and/or amplitude tuner 70″ for one of the two modes of modified probe light only. It is advantageously arranged to tune the mode that will be dominant during the measurement.

If it is not possible to predict which of the modes will be dominant, there is, advantageously, a dedicated amplitude tuner for each of both modes such that the amplitude of the stronger mode can be tuned down to match the one of the weaker mode. A phase tuner, where required, can be located to tune any of the two modes, or there can be phase tuners for both modes.

The first output 37a″ of second beam combiner 30″ is then fed to first beam combiner 30′, where it is brought to interference with the reference probe light. Again, a phase and/or amplitude tuner 70′ is provided to tune the relative phase and/or amplitude of the reference probe light and the light from first output 37a″.

Control unit 42 is adapted to tune phase and/or amplitude tuner 70′, by means of tuning parameters t1′, t2′, in order to minimize the signal I1′ from the photodetector D1′ detecting the light at the first output 37a′ of first beam combiner 30′. The relative phase as well as the relative powers of the (interfered) modified probe light from output 37a″ and the reference probe light can then be determined from the tuning parameters t1′, t2′.

In the embodiment of FIG. 4, first beam combiner 30′ again has complementary outputs 37a′, 37b′, both of which are coupled to photodetectors D1′, D2′. Same as above, only one of them is required for determining the tuning parameters t1′, t2′. The other one is not strictly required but may e.g. be used to monitor system operation.

### Fifth Embodiment

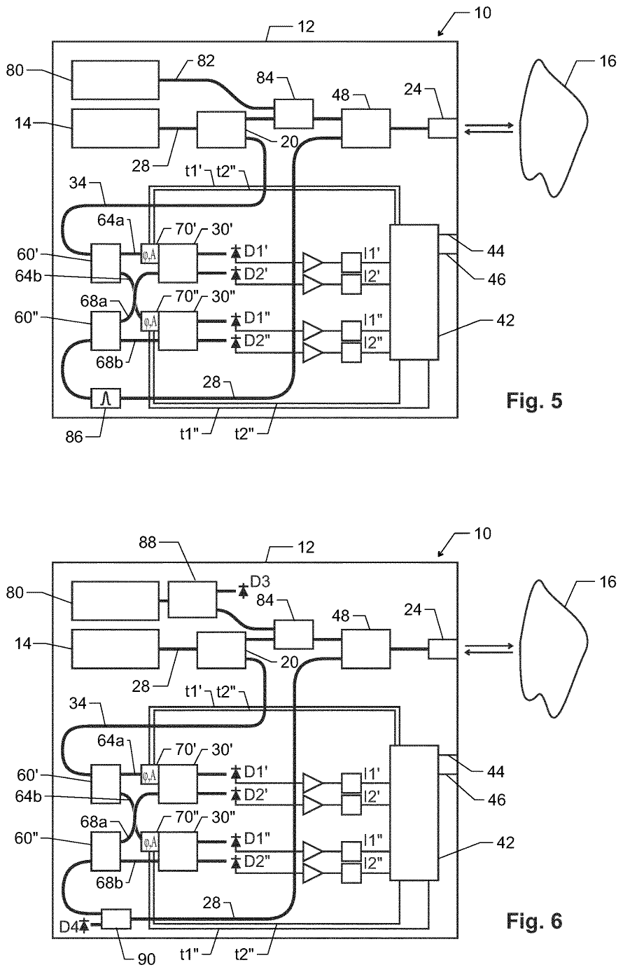

FIG. 5 illustrates one way to use the present technique for determining third-order nonlinear optical effects in sample 16, in particular for measuring stimulated Raman scattering.

In the example of FIG. 5, device 10 comprises a secondary light source 80 in addition to probe light source 14. Secondary light source 80 generates light having a center wavelength different from the probe light.

The secondary light is sent, e.g. by means of an integrated waveguide 82, to a beam combiner 84, where it is combined with the probe light from beam splitter 20. From there, the combined secondary and sample probe light is sent to sample 16 (e.g. via beam splitter 48 if device 10 has a single device terminal 24 for sending and receiving light to/from sample 16).

At sample 16, the secondary light and the sample probe light overlap. If third-order nonlinear optical effects occur in sample 16, energy may be transferred between the sample probe light and the secondary light. Hence, the light at the wavelength of the probe light undergoes a change in amplitude and/or phase at least for one polarization.

For example, if the wavelength difference between the secondary light and the probe light corresponds to a vibrational mode of a molecular component of sample 16, stimulated Raman gain or loss take place at the wavelength of the probe light.

The modified probe light is received by device 10 and then processed, e.g. using the techniques as described in the above embodiments. The sole difference is that the light returning from sample 16 typically comprises not only the modified probe light but also some of the secondary light, which may have to be removed before processing the modified probe light. In the embodiment of FIG. 5, a bandpass or other filter 86, such as a low-pass or high-pass filter, is provided somewhere along the path of the modified probe light to do so. If implemented as a bandpass filter, 86 is advantageously centered on the wavelength of the probe light and adapted to block the wavelength of the secondary light.

In the embodiment of FIG. 5, the techniques of the third embodiment are used to analyze the amplitude, phase, and/or polarization state of the modified probe light. However, other similar techniques, such as those of the other previous embodiments, may be used to retrieve at least part or all of these parameters.

### Sixth Embodiment

FIG. 6 illustrates some more concepts of using a device with a secondary light source 80 that can be applied to various embodiments of the present technique.

This embodiment differs from the fifth embodiment by having a beam splitter 88 that sends part of the secondary light to a photodetector D3 for monitoring the power of the secondary light, e.g. for controlling the operating parameters of secondary light source 80.

Further, bandpass filter 86 of the fifth embodiment is replaced by a wavelength-selective splitter 90 adapted to split light at the wavelength of the secondary light to a photodetector D4 while light at the wavelength of the probe light is forwarded to the phase and amplitude detection hardware. This allows to measure the amount of light at the wavelength of the secondary light that returns from sample 16, which in turn provides a further means for assessing the properties of sample 16.

### Tunable Couplers and Splitters

As seen from the above, examples, the present technology can advantageously be implemented using tunable couplers and splitters for tuning the reference probe light and/or the probe light in order to obtain destructive interference at the photodetector. For example, in the embodiment of FIG. 1, splitter 20 is a tunable splitter, and in the embodiment of FIG. 2, beam combiner 30 is a tunable beam combiner.

In the embodiments of FIGS. 2-6, the beam combiners 30, 30′, 30″ have two inputs and two outputs, with the outputs being complementary (i.e. with the power going to one or the other output depending on the tuning of the beam combiner and the relative amplitudes and phase shift of the light at its inputs).

Such a tunable beam combiner can be used to generate destructive interference at one of its outputs and a monitoring signal, or light for further processing as in the example of FIG. 4, at its other output. In more general terms, therefore, the invention advantageously comprises the steps of:
Sending the reference probe light and/or the modified probe light to a tunable beam combiner having two inputs and two complementary outputs. Depending on the tuning, the light from the inputs ends up at one or the other output or at both.
Minimizing, using the tuning parameter(s), the intensity output at one of the two complementary outputs.

As mentioned above, tunable splitters and/or combiners can e.g. be implemented by coupling two sections of waveguide and by modifying their coupling by means of a heater (or e.g. by an electrical field and electro-optic effects).

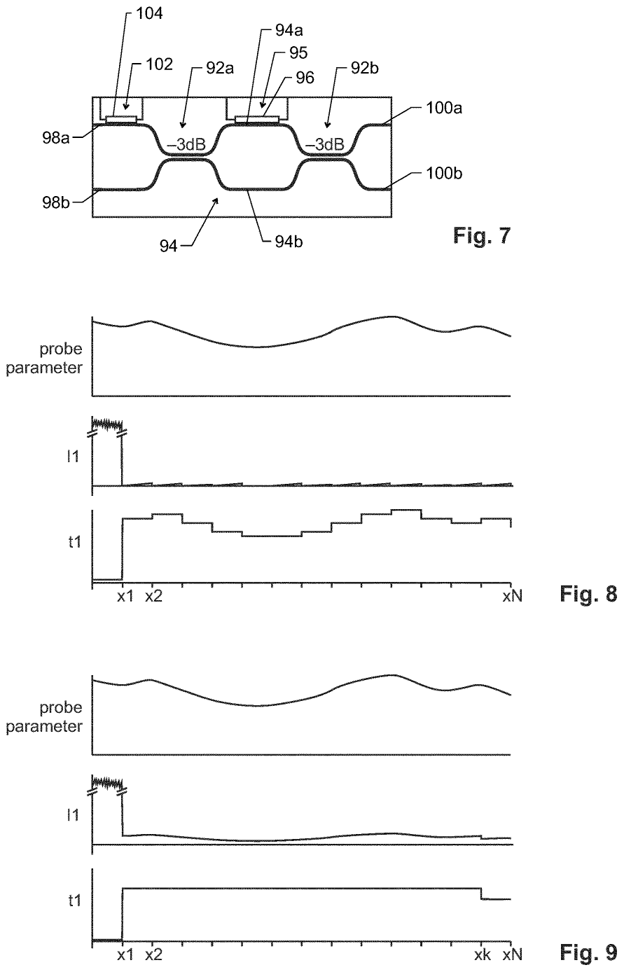

Another advantageous embodiment for implementing such a tunable splitter or beam combiner is shown in FIG. 7. Here, two-3 dB directional couplers 92a, 92b are used to form an interferometer 94, in particular a Michelson interferometer, between them. The optical length (i.e. the phase shift) of at least one of the interferometer arms 94a, 94b is tunable by means of a first tunable phase shifter 95, e.g. implemented by a heater 96.

Hence, by tuning first tunable phase shifter 95, the output powers at the first and second outputs 100a, 100b can be controlled, which allows to use this device as a tunable beam splitter, e.g. as beam splitter 20 in the embodiments above, for controlling the relative powers of the sample probe light and the reference probe light. In this application, the probe light from probe light source 14 is fed to one of the inputs 98a, 98b of the device of FIG. 7 while no signal is applied to the other input.

The device of FIG. 7 can also be used as a tunable beam combiner for analyzing the modified probe light, e.g. as a beam combiner 30, 30′, 30″ in the examples above. In this case, both inputs 98a, 98b are used. If the two signals at the inputs 98a, 98b have equal phase, the phase difference between the two arms 94a, 94b alone controls the coupling of each input 98a, 98b into the first and second output 100a, 100b. In other words, controlling the phase difference between the arms 98a, 98b, e.g. by means of first phase shifter 95, allows to control how the light at the two inputs 98a, 98b is distributed between the two outputs 100a, 100b.

If there is a non-zero phase shift between the two signals at the inputs 98a, 98b, interference will cause additional mixing between the signals at the two outputs. Hence, advantageously, a second tunable phase shifter 102, e.g. implemented by means of another heater 104, may be added to at least one of the inputs 98a, 98b.

Hence, by tuning the first and second phase shifter 95, 102, it is possible to obtain fully destructive interference at a first output, e.g. output 100a, and to direct all the light to the second output, e.g. output 100b.

This type of tunable beam combiner may, as mentioned, e.g. be used as beam combiner 30, 30′, or 30″ in the embodiments above.

For a more detailed description of dimensioning interferometers of this type, reference is made to Horst et al., Optics Express Vol. 21, Issue 10, pp. 11652-11658 (2013), https://doi.org/10.1364/OE.21.011652.

### Calibration

As mentioned, the at least one sample parameter(s) can be determined from the tuning parameter(s).

In some applications, it is sufficient to determine the sample parameter(s) in a relative or qualitative manner, e.g. it may be sufficient to determine e.g. a relative change of absorption or a relative change in phase. In this case, device 10 does not necessarily have to be calibrated.

In other applications, e.g. for measuring an absolute change of length or an absolute change of absorption of sample 16, calibration of the device may be advantageous. To calibrate device 10, a reference sample may e.g. be used instead of sample 16, such as a calibrated movable mirror or a calibrated adjustable absorber (e.g. a set of filters). Using such a reference sample, it is possible e.g. to scale a phase tuning parameter to an absolute phase change or an amplitude tuning parameter to an absolute change of absorption.

### Applications

In the following, some applications of the technique are described in more detail.

### Transmission or Reflection:

In one embodiment, the present technique can be used for measuring linear transmission through and/or reflection from sample 16.

For example, sample 16 may be a gas the refractive index and/or absorption of which changes slightly when modifying a sample parameter, such as its composition, and sample 16 is measured in transmission, i.e. the modified probe light is the light transmitted through sample 16.

In another example, sample 16 is a mirror that specularly reflects the sample probe light, and the position of the mirror changes (e.g. by fractions of a wavelength). In this case, the sample parameter to be measured may be the position of the mirror, and the modified probe light changes phase as a function of the sample parameter.

In both of the above examples, sample 16 does not change the polarization state of the modified probe light as a function of the sample parameter.

Hence, even though all of the embodiments of device 10 described above would be able to successfully analyze the modified probe light, a device as simple as the one of FIG. 1 can be used.

This class of measurements may also include NIR reflection/absorption spectroscopy and/or Fourier-transform infrared spectroscopy (FTIR).

### Optical Rotation:

In another embodiment, sample 16 may generate an optical rotation in the sample probe light that varies with the sample parameter. For example, sample 16 may be a fluid having a chiral, optically active component, and the sample probe light is sent through the fluid. In this case, the polarization state of the modified probe light will depend on the concentration of the optically active component, which in this case forms the sample parameter.

In this application, device 10 may be equipped to determine the polarization state of the modified probe light, e.g. using the techniques of one of the embodiments of FIG. 3 or 4.

### Elastic Scattering:

In another embodiment, sample 16 may elastically scatter the sample probe light, and the modified probe light will be scattered sample probe light. In this case, the sample parameter may e.g. be a concentration and/or another parameter (such as particle distribution or composition) of the scattering components in the sample. The sample parameter typically affects the amplitude, phase, and polarization state of the modified probe light.

Hence, in this application, the techniques of e.g. one of the embodiments of FIG. 3 or 4 may be used.

### Wavelength Dependence:

In a large number of applications, measurements are advantageously carried out for different wavelengths of the probe light.

In this case, for example, probe light source 14 may be a wavelength-tunable light source, such as a wavelength-tunable laser. If a secondary light source 80 is used, secondary light source 80 may also be a wavelength-tunable light source, such as a wavelength-tunable laser, in addition to or alternatively to probe light source 14 being a wavelength-tunable light source.

The present system is particularly suited for carrying out measurements at different wavelengths because it is able to tune itself. Hence, if a component, such as a beam splitter or beam combiner, has, to some degree, wavelength-dependent properties, a re-tuning of the system will still allow to achieve destructive interference, and the system can be used at several wavelengths.

Closed-Loop Vs. Open-Loop Control:

There are different ways to operate device 10 over a series of measurements.

FIG. 8 shows a first, “closed-loop” scheme, where control unit 42 adjusts the tuning parameter(s) t1, t2 . . . to set the measured intensity parameter(s) to zero for each of a series of measurements x1 . . . xN.

For simplicity, the figure shows the parameters for a system that has a single tuning parameter t1 and measures a single intensity parameter I1.

At the beginning, the intensity parameter I1 has not yet been optimized for reduced interference. It therefore exhibits a strong DC offset and strong shot noise, as schematically illustrated. At the time of the first measurement x1, control unit 42 measures intensity parameter I1 and then adjusts tuning parameter t1 to make intensity parameter I1 zero. The value of tuning parameter t1(x1) at x1 is the result of the measurement. At the time of the next measurement x2, the sample parameter has changed to some degree and, therefore, intensity parameter I1 has deviated from zero. Control unit 42 then again measures intensity parameter I1 and adjusts tuning parameter t1 to make intensity parameter I1 zero. t1 (x2) is the result of the measurement at x2. This procedure is repeated for each measurement xi in a series of N>1, in particular N>10, measurements.

Tuning parameter t1(xi) thus follows the changes of the sample parameter, and the value of the tuning parameter (after tuning) at a given measurement is indicative of the value of the sample parameter. In other words, the value of the sample parameter (or its change) can be derived from the tuning parameter t1.

The scheme of FIG. 8 has the advantage that the measurements, after tuning, do not suffer from shot noise, and therefore the sample parameter can be derived with great accuracy from t1 even if it varies only slightly.

FIG. 9 shows a second, “open-loop” scheme, where control unit 42 does not adjust the tuning parameter(s) for each measurement xi. Rather, it only adjusts the tuning parameter(s) at certain times to generate fully or at least partically destructive interference at the photodetector(s) at certain times and then keeps the tuning parameter(s) constant over several measurements.

Again, for simplicity, the figure shows the parameters for a system that has a single tuning parameter t1 and measures a single intensity parameter I1.

Before tuning the device 10, intensity parameter I1 has a strong DC offset and is fraught with shot noise. Then, for example, at the time of the first measurement x1, control unit 42 changes the tuning parameter t1 to reduce the intensity parameter I1, advantageously by several orders of magnitude as compared to the non-tuned state, thereby reducing shot noise.

Then, for several subsequent measurements x2, x3 . . . xk, tuning parameter t1 is kept constant. Hence, intensity parameter I1 is non-zero and varies with the sample parameter. However, if the sample parameter varies only weakly, intensity parameter I1 will remain low, i.e. shot noise will remain low.

In this case, the sample parameter for a given measurement xi can be derived from the values of tuning parameter t1 and intensity parameter I1 at xi. If only the relative change of the sample parameter as compared to the first measurement x1 is of interest, this relative change may even be derived from the intensity parameter I1 at x1, x2 . . . alone.

The scheme of FIG. 8 has the advantage that fewer recalculations of the tuning parameter(s) and tuning steps are required, which may e.g. allow to increase the measurement rate and/or to reduce power consumption of the system. The shot noise will, however, be slightly larger than in the closed-loop scheme.

At the times when, in the open-loop scheme, the tuning parameter(s) are recalculated, they can be set to such a value that the intensity parameter(s) become zero. This further reduces shot noise. However, it may have the disadvantage that disambiguation is required. For example, if the sample parameter affects the phase shift of the modified probe light, at a given time, and the tuning parameter(s) is/are set such that the intensity parameter(s) becomes zero, a non-zero value of the intensity parameter(s) at the next measurement will indicate that the phase shift has changed, but—without changing the tuning parameters again—the sign of the phase shift may be unknown. Similarly, simultaneous changes in phase, amplitude and/or polarization might generate ambiguities. Hence, e.g. in the embodiment as depicted in FIG. 9, the tuning parameter(s) are advantageously set to a value where the intensity signal(s) is/are decreased by several orders of magnitude (to reduce shot noise), but they are not tuned to zero.

### Stimulated Raman Scattering:

Measurements of stimulated Raman scattering (SRS) are a particularly important application of the present technique because, in classical SRS, the scattering parameters generate small relative variations in the intensity of the light returning from the sample. Hence, the signal of interest is typically overlaid with strong shot noise.

For SRS, pump light as well as stokes light is required. Hence, SRS can e.g. be measured with embodiments of the present application that comprise, in addition to probe light source 14, a secondary light source 80 as e.g. shown FIGS. 5 and 6.

In this case, the center wavelengths of the probe light and the reference probe light should, as mentioned above, be different, with the frequency difference being chosen to excite rotational or vibrational modes of the molecules in sample 16.

In one embodiment, the sample probe light from sample light source 14 corresponds to the pump light while the secondary light from secondary light source 80 corresponds to the Stokes light. In another embodiment, the sample probe light from sample light source 14 corresponds to the Stokes light while the secondary light from secondary light source 80 corresponds to the pump light. Since device 10 measures the phase, intensity, and (if desired) polarization of the modified probe light, the device may either measure gain or loss in the pump light or in the Stokes light.

Advantageously, in order to carry out spectroscopic SRS measurements, at least one of the probe light source 14 and the secondary light source 80 is a wavelength-tunable light source.

Advantageously, the center wavelength of the wavelength-tunable light source is tunable over at least 20 nm. More preferably, the light source is tunable over more than 50 nm. It is preferred that the light source can be tuned over at least 75 nm.

Advantageously, the tunable light source can be tuned mode-hop-free over said wavelength range.

### Some Examples

A) Probe light source 14 may have a fixed wavelength while secondary light source 80 may have a tunable wavelength, with the wavelength of secondary light source 80 being longer than the wavelength of the pump light source 14. For example, the probe light may have a fixed wavelength of 785 nm and the secondary light source 80 may be a tunable Stokes laser having a tunable range of at least 800 . . . 900 nm.

B) Probe light source 14 may have a tunable wavelength while secondary light source 80 may have a fixed wavelength, with the wavelength of probe light source 14 being longer than the wavelength of the secondary light source 80. For example, probe light source 14 may be a tunable Stokes laser having a tunable range of at least 800 . . . 900 nm, and the secondary light may have a fixed wavelength of 785 nm.

When performing a series of measurements at several wavelengths, the closed-loop or the open-loop control scheme of the previous section may be used.

Hence, in the closed-loop control scheme, the tuning parameters t1′, t2′, t1″, t2″ are derived from the measured intensity parameters, and the phase and/or intensity tuners 70′, 70″ are controlled by means of the tuning parameters in order to generate destructive interference and to make the detected intensity parameters I1′, I1″ zero.

In the open-loop control scheme, on the other hand, the tuning parameters t1′, t2′, t1″, t2″ are derived and destructive interference is generated at the measurement at one wavelength to bring the intensity parameter at least close to zero. Then, several measurements are carried out at other wavelengths without updating the tuning parameters, and the deviation of the intensity parameters I1′, I1″ from zero is tracked.

As mentioned above, an optical filter 86 and/or a wavelength-selective splitter 90 may be used for removing the secondary light from the modified probe light before bringing it to the photodetector(s). If a wavelength-selective splitter 90 is used, a second analyzer may be provided, comprising its own beam splitters (equivalent to the splitters 60′, 60″) and beam combiners (equivalent to the beam combiners 30′, 30″) for generating interference between modified secondary light returning from sample 16 and reference secondary light derived from the secondary light of secondary light source 80, and these components may again be tuned for destructive interference, thereby allowing to measure the gain/loss of both the pump light and the Stokes light with high accuracy.

### Polarization Analysis:

The embodiments of FIGS. 3-6 are adapted to detect the change of polarization in the modified probe light returning from sample 16.

In general, the polarization of the modified probe light can be described by the relative amplitude and/or relative phase of two orthogonal polarization states of the modified probe light. These states may e.g. be two orthogonally oriented linear polarization components or the two orthogonal circular polarization components (e.g. the L- and R-polarization states).

The present method advantageously comprises the step of determining the relative amplitude and/or phase of two orthogonal polarization states of the modified probe light.

In one embodiment, e.g. using the device of FIG. 3, the two polarization states of the modified probe light are each made to interfere with the reference probe light, and the phases and/or amplitudes of each polarization state in respect to the reference probe light are tuned in order to generate destructive interference of each polarization state with the reference probe light by determining at least a first and a second tuning parameter t1′, t2′, t1″, t2″ for at least two phase and/or intensity tuners.

In another embodiment, e.g. using the device of FIG. 4, the two polarization states of the modified probe light are made to interfere with each other, and the relative phases and/or amplitudes of the two polarization states in respect to each other are tuned in order to generate destructive interference of the polarization states with each other by determining at least a first tuning parameter t1″, t2″ for a first phase and/or intensity tuner 70″. Further, “derived light” (e.g. the light at output 37a″ of FIG. 4) from one or both of the polarization states is also made to interfere with the reference probe light, and the phase and/or amplitude of the derived light in respect to the reference probe light is/are tuned in order to generate destructive interference by determining at least a second tuning parameter t1′, t2′ for a second phase and/or intensity tuner 70′

### Notes

Generally, as described above, the relative phase between the reference probe light and the modified probe light is modified, by means of the tuning parameter(s), to make the reference probe light and the modified probe light interfere destructively. In addition or alternatively thereto, the relative intensity (i.e. power) of the reference probe light and the modified probe light is modified by means of the tuning parameter(s), to make the reference probe light and the modified probe light interfere destructively.

As mentioned, the tunable element(s) controlled by the tuning parameter(s) may be arranged in the path of the reference probe light and/or in the path of the probe light. In the latter case, they may be arranged in the path of the sample probe light (i.e. before the probe light reaches the sample) and/or in the path of the modified probe light (i.e. after the probe light has reached the sample).

The tunable element(s) may also be incorporated, at least in part, in the beam splitter that splits the sample probe light and the reference probe light, or in the beam combiner(s) that combine the reference probe light and the modified probe light.

In some of the above embodiments, a wavelength-tunable light source is used. Such a light source may include a continuously tunable light source (such as a tunable laser or a broadband light source with a tunable filter) or e.g. an assembly of several light sources having different center wavelengths that are operated e.g. sequentially.

Advantageously, the components of device 10 are integrated on a single substrate, which provides for a more robust and stable operation.

While there are shown and described presently preferred embodiments of the invention, it is to be distinctly understood that the invention is not limited thereto but may be otherwise variously embodied and practiced within the scope of the following claims.

1. A method for optically measuring at least one sample parameter of a sample comprising
generating probe light by means of a probe light source,
splitting said probe light into sample probe light and reference probe light,
causing the sample probe light to interact with the sample, thereby generating modified probe light having a phase and/or intensity depending on said sample parameter,
causing the modified probe light to interfere with the reference probe light at a beam combiner, thereby generating signal light,
measuring at least one intensity parameter of the signal light by means of at least one photodetector,
deriving a tuning parameter using the intensity parameter and controlling a phase and/or intensity tuner by means of the tuning parameter to modify a relative phase and/or intensity of the interfering reference probe light and modified probe light to make them interfere destructively, and
deriving the sample parameter using at least one of the intensity parameter and the tuning parameter.

2. The method of claim 1 comprising
repetitively deriving said tuning parameter at a plurality of times and minimizing the intensity parameter at said plurality of times, and
deriving the sample parameter using the tuning parameters at said plurality of times.

3. The method of claim 1 comprising the step of deriving the sample parameter using the tuning parameter but not the intensity parameter.

4. The method of claim 1 comprising
a) deriving the tuning parameter and reducing the intensity parameter by destructive interference,
b) after said step a), keeping the tuning parameter unchanged and measuring the intensity parameter at several times,
c) deriving the sample parameter using the intensity parameters measured at the several times.

5. The method of claim 1, wherein the relative phase between the reference probe light and the modified probe light is modified to make them interfere destructively.

6. The method of claim 1, wherein the relative intensity of the reference probe light and the modified probe light is modified to make them interfere destructively.

7. The method of claim 1 wherein a tunable beam splitter is used to split the probe light into the sample probe light and the reference probe light and wherein the tuning parameter is used to tune a splitting ratio of the tunable beam splitter.

8. The method of claim 1 wherein at least of the sample probe light, the modified probe light, and the reference probe light is fed through a tunable phase shifter and wherein the tuning parameter is used to tune a phase delay of the tunable phase shifter.

9. The method of claim 1 comprising
feeding the reference probe light and the modified probe light into at least one Mach-Zehnder interferometer comprising two arms extending between directional couplers and a tunable phase shifter in at least one of said arms, and
using the tuning parameter to tune a phase delay of the tunable phase shifter.

10. The method of claim 1 comprising
sending the reference probe light and/or the modified probe light to a tunable beam combiner having two inputs and two complementary outputs and
minimizing, using the tuning parameter, an intensity output at one of the two complementary outputs.

11. The method of claim 1 comprising the step of determining a relative amplitude and/or phase of two orthogonal polarization states of the modified probe light.

12. The method of claim 11 further comprising
making each of the two polarization states of the modified probe light interfere with the reference probe light, and
tuning the relative phases and/or amplitudes of each polarization state in respect to the reference probe light to generate destructive interference of each polarization state with the reference probe light by determining at least a first and a second tuning parameter for at least two phase and/or intensity tuners.

13. The method of claim 11 further comprising
making the two polarization states of the modified probe light to interfere with each other,
tuning the relative phases and/or amplitudes of each polarization state in respect to each other in order to generate destructive interference of the polarization states with each other by determining at least a first tuning parameter for a first phase and/or intensity tuner,
making derived light obtained from at least one of the polarization states interfere with the reference probe light, and
tuning the phase and/or amplitude of the derived light in respect to the reference probe light in order to generate destructive interference by determining at least a second tuning parameter for a second phase and/or intensity tuner.

14. The method of claim 1 further comprising
generating secondary light by means of a secondary light source, wherein the secondary light has a wavelength different from the probe light,
overlapping the secondary light and the sample probe light at the sample and causing the secondary probe light and the sample probe light to interact with the sample, thereby generating the modified probe light having a phase and/or intensity depending on said sample parameter as well as on an intensity of the secondary probe light.

15. The method of claim 14 comprising
changing a wavelength of at least one of the probe light source and the secondary light source, and
determining the sample parameter for several wavelengths.

16. The method of claim 15 comprising, for each wavelength, deriving the tuning parameter from the intensity parameter and controlling the phase and/or intensity tuner by means of the tuning parameter to modify a relative phase and/or intensity of the reference probe light and the modified probe light to make them interfere destructively, thereby minimizing the intensity parameter.

17. The method of claim 15 comprising,
a) for a first wavelength, deriving the tuning parameter from the intensity parameter and controlling the phase and/or intensity tuner by means of the tuning parameter to modify a relative phase and/or intensity of the reference probe light and the modified probe light to make them interfere destructively, thereby reducing the intensity parameter,
b) after said step a), keeping the tuning parameter unchanged and measuring the intensity parameter for several second wavelengths,
c) deriving the sample parameter at the second wavelengths using the intensity parameters measured at the second wavelengths.

18. The method of claim 14 comprising the step of changing the wavelength of the secondary light source.

19. The method of claim 1 comprising the step of changing the wavelength of the probe light source.

20. The method of claim 1 wherein a coherence length of the probe light is at least 1 mm.

21. An optoelectronic measurement device comprising
a probe light source,
a probe light splitter connected to the probe light source,
a sample interface connected to the probe light splitter,
a beam combiner connected to the probe light splitter and the sample interface,
a photodetector connected to the beam combiner,
a phase and/or intensity tuner, and
a control unit adapted to carry out the method of claim 1.

22. The method or device of claim 1 comprising using the sample parameter for stimulated Raman spectroscopy measurements.
